(19) United States
(12) Patent Application Publication
(10) Pub. No.: US 2026/0340723 A1
(43) Pub. Date: Oct. 29, 2026

(54) HARDWARE-ATTESTED TRADE INTEGRITY SYSTEM FOR PREDICTION MARKET EXCHANGES

(71) Applicant: George William Bickerstaff, III, Greenwich, CT (US)

(72) Inventor: George William Bickerstaff, III, Greenwich, CT (US)

(21) Appl. No.: 19/714,057

(22) Filed: Jun. 19, 2026

(51) Int. Cl. G06Q 40/04; H04L 9/08

(52) U.S. Cl. CPC G06Q 40/042; H04L 9/083

(57) ABSTRACT

A hardware-attested system detects trade-integrity violations at a prediction market exchange within a trusted execution environment. The system ingests order-flow and account-metadata records over an encrypted channel terminating within the enclave, computes cryptographic account-linkage fingerprints, and identifies groupings of accounts whose pairwise linkage scores exceed a configured threshold. A surveillance module generates raw trade-integrity signals classifying trade patterns as wash-trading, coordinated-trading, or collusion indicators, and makes these signals and the linkage fingerprints available for a companion scoring engine to compute a calibrated insider-risk indicator; the system itself performs detection only. An attestation module produces a hardware-attestation quote binding the surveillance code measurement, commitments to the ingested records and surveillance parameters, and the raw signals, verifiable by a relying party against a hardware-vendor attestation service independently of the exchange operator.

### CROSS-REFERENCE TO RELATED APPLICATIONS

This application claims the benefit of U.S. Provisional Application No. 64/043,908, filed Apr. 20, 2026, the entire contents of which are incorporated herein by reference. This application is related to commonly-owned co-pending applications directed to companion systems including a verified prediction confidence scoring engine (VPCS), a regulatory-compliant wrapper system (RCW), a federated stack orchestrator (FSO), a multi-exchange consolidated platform (MECP), and a resolution-outcome oracle (Oracle Resolution), the contents of which are incorporated herein by reference to the extent consistent herewith. Subject matter directed to a hardware-attested resolution-outcome flow and to deterministic regulator re-execution of a surveillance code base, disclosed in the above-identified provisional application, is reserved for one or more separate applications and is not claimed herein.

### FIELD OF THE INVENTION

The present invention relates to regulated financial market infrastructure, and more particularly to a hardware-attested system that detects trade-integrity violations at a prediction market exchange within a hardware trusted execution environment and produces raw trade-integrity signals and account-linkage fingerprints, together with a hardware-attestation quote, that a relying party can verify independently of the exchange operator.

### BACKGROUND OF THE INVENTION

Prediction market exchanges are subject to market-surveillance obligations comparable to those of other regulated trading venues, including the detection of wash trading, coordinated trading, and collusion among non-independent accounts. A surveillance result produced by exchange-operated software affords a relying party no cryptographic means of confirming that the surveillance was performed on unaltered order-flow data, by unmodified surveillance code, without the exchange operator's ability to suppress or alter detections.

Moreover, surveillance detection is distinct from the downstream scoring and capital treatment that institutional consumers require: raw detection of suspicious trade patterns and computation of account linkages is a different technical function from the calibration of those detections into an insider-risk score. A clear need exists for a hardware-attested system that performs trade-integrity detection within a hardware-protected enclave, emits raw trade-integrity signals and account-linkage fingerprints as attested outputs consumable by a downstream scoring engine, and produces a hardware-attestation quote that a regulator can verify independently of the exchange operator. The present invention addresses this need.

### SUMMARY OF THE INVENTION

The invention is directed to a hardware-attested trade integrity system comprising a hardware trusted execution environment loading a measured surveillance code base, an order-intake interface, a linkage-analysis module, a surveillance module, and an attestation module.

In one aspect, the system ingests order-flow records and account-metadata records into the enclave over an encrypted channel; computes cryptographic account-linkage fingerprints and identifies groupings of accounts whose pairwise linkage scores exceed a configured threshold; generates raw trade-integrity signals classifying trade patterns as wash-trading, coordinated-trading, or collusion indicators; and produces a hardware-attestation quote binding the surveillance code measurement, commitments to the ingested records and surveillance parameters, and the raw trade-integrity signals, verifiable by a relying party against a hardware-vendor attestation service independently of the exchange operator.

Consistent with the companion-system architecture, the system performs detection only: it generates the raw trade-integrity signals and account-linkage fingerprints and makes them available for consumption by a companion verified prediction confidence scoring engine that computes a calibrated insider-risk indicator therefrom. The system does not itself compute the calibrated insider-risk indicator. Subject matter directed to a resolution-outcome oracle and to deterministic regulator re-execution, disclosed in the priority application, is not claimed herein and is reserved for separate applications.

### BRIEF DESCRIPTION OF THE DRAWINGS

FIG. 1 depicts the hardware-attested trade integrity system architecture and its trust model, in subfigures FIG. 1A through FIG. 1E.

FIG. 2 depicts the end-to-end surveillance-record production sequence, in subfigures FIG. 2A through FIG. 2E.

FIG. 3 depicts account-linkage fingerprint analysis, in subfigures FIG. 3A through FIG. 3E.

FIG. 4 depicts the raw trade-integrity signal taxonomy, in subfigures FIG. 4A through FIG. 4E.

FIG. 5 depicts the attested audit-record export architecture, in subfigures FIG. 5A through FIG. 5E.

### DETAILED DESCRIPTION OF PREFERRED EMBODIMENTS

### Definitions

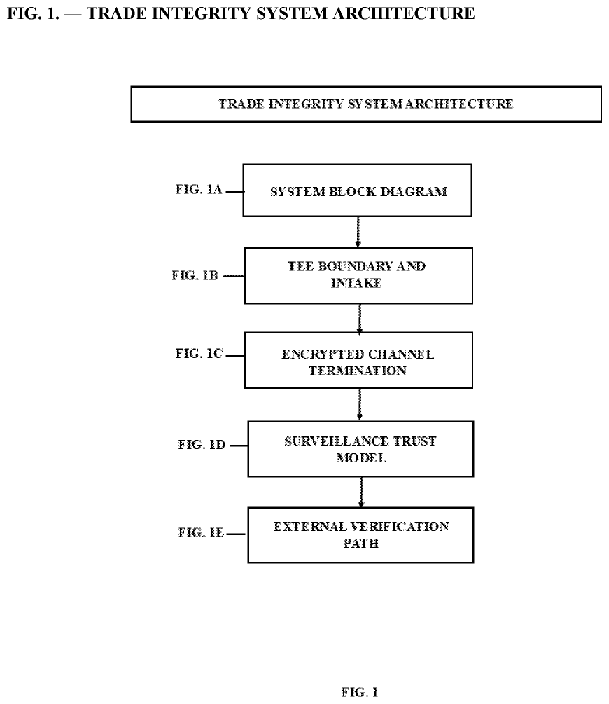

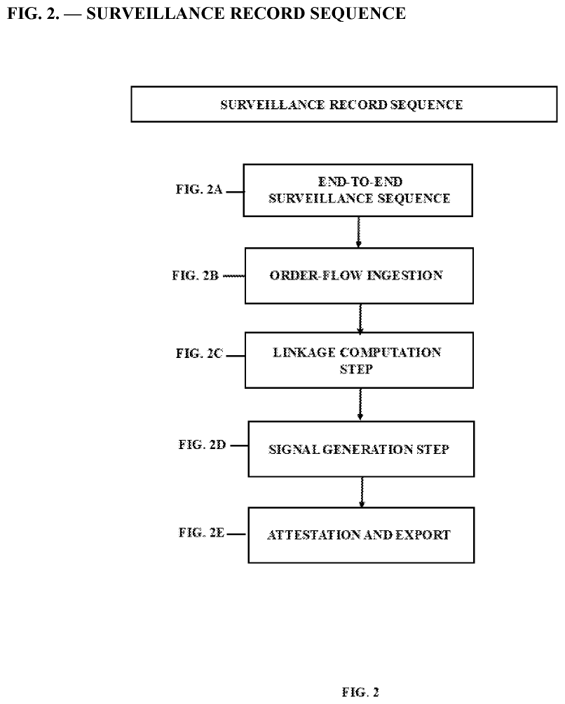

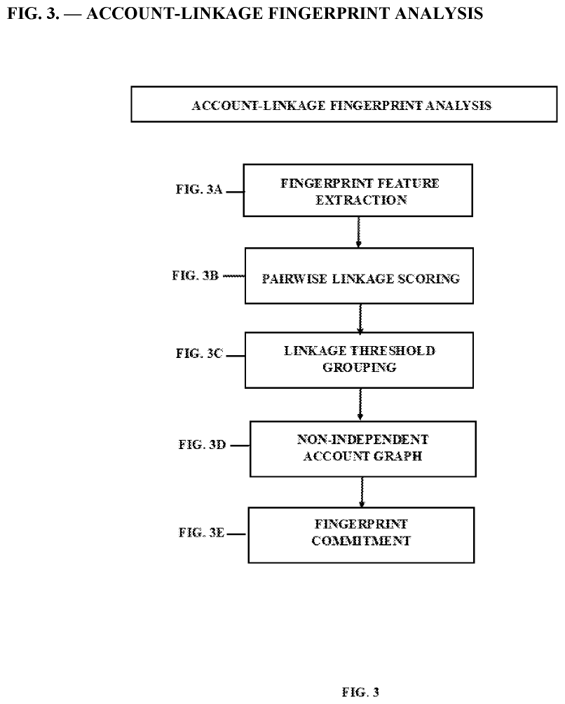

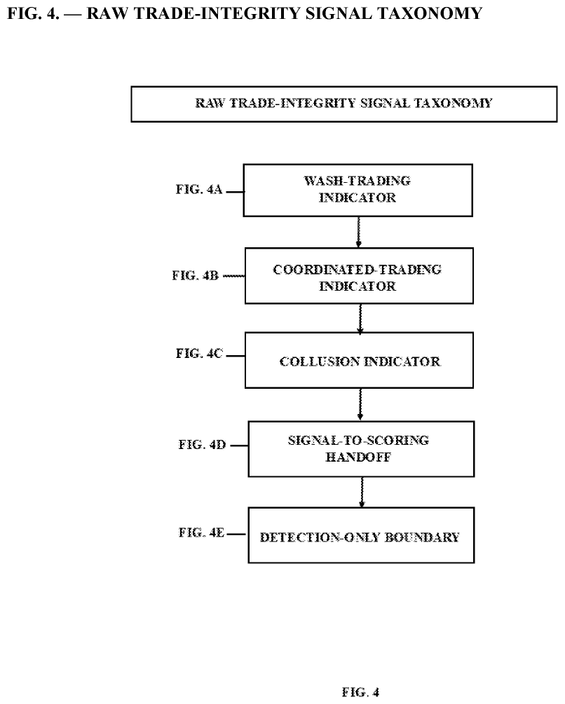

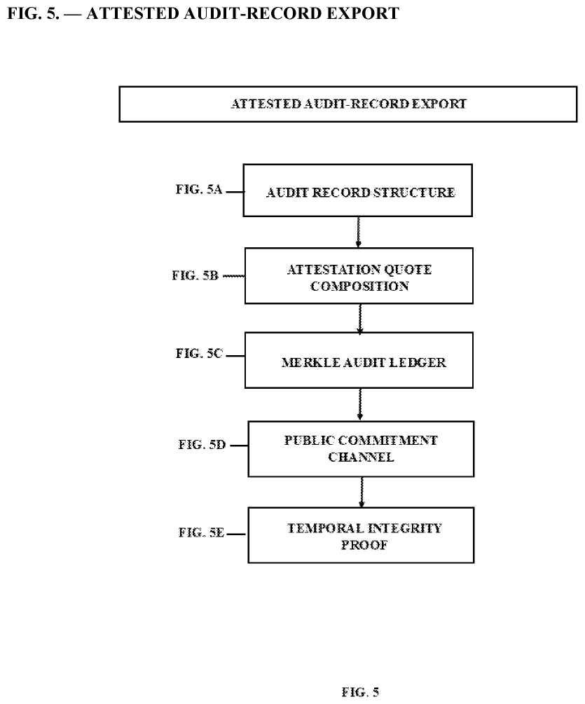

As used herein, the following terms have the meanings set forth below. The definitions are inclusive and non-limiting; each term includes, but is not limited to, the described subject matter.
“Account-Linkage Fingerprint” means a cryptographic representation computed from features of order-flow and account-metadata records that characterizes a relationship between two or more accounts, including but not limited to representations enabling identification of non-independent or commonly-controlled accounts.
“Attestation Module” means a component executing within or in conjunction with the hardware trusted execution environment configured to produce a hardware-attestation quote, including but not limited to a quote binding a code measurement, input commitments, parameter commitments, and raw trade-integrity signals.
“Covered Interval” means a time interval over which order-flow and account-metadata records are ingested and surveilled and over which a hardware-attestation quote is produced, including but not limited to a fixed window or a rolling window.
“Hardware Measurement Register” means a hardware-protected register whose contents cryptographically bind to a measured code base upon instantiation, including but not limited to platform configuration registers and equivalent measurement facilities.
“Hardware-Attestation Quote” means a cryptographic artifact produced under a hardware-rooted attestation key and verifiable against a hardware-vendor attestation service, including but not limited to a quote binding a surveillance code measurement, input and parameter commitments, and raw trade-integrity signals.
“Linkage-Analysis Module” means a component executing within the hardware trusted execution environment configured to compute account-linkage fingerprints and to identify groupings of accounts whose pairwise linkage scores exceed a configured linkage threshold.
“Order-Flow Record” means a record of trading activity at a prediction market exchange, including but not limited to order submissions, cancellations, modifications, and executions, and associated timestamps and prices.
“Raw Trade-Integrity Signal” means a signal generated by the surveillance module classifying a trade pattern, including but not limited to a wash-trading indicator, a coordinated-trading indicator, or a collusion indicator, prior to and distinct from any calibrated insider-risk indicator computed downstream by a companion scoring engine.
“Surveillance Module” means a component executing within the hardware trusted execution environment configured to generate raw trade-integrity signals based at least in part on account groupings and order-flow records.
“Trusted Execution Environment (TEE)” means a hardware-protected execution environment providing measurement, isolation, and remote attestation, including but not limited to Intel SGX, Intel TDX, AMD SEV-SNP, ARM CCA, and IBM Secure Execution.
I. System Architecture Overview. FIG. 1 depicts a hardware-attested trade integrity system organized around a hardware trusted execution environment loading a measured surveillance code base, comprising an order-intake interface, a linkage-analysis module, a surveillance module, and an attestation module (FIG. 1A). Order-flow and account-metadata records are delivered into the enclave over an encrypted channel terminating within the TEE boundary, with plaintext isolation from the host (FIG. 1B-1C). The trust model comprises the hardware measurement register, the hardware-rooted attestation key, committed surveillance parameters, and the hardware-vendor attestation service as external trust anchor (FIG. 1D-1E).
II. Order-Intake Interface. The order-intake interface delivers order-flow records and account-metadata records associated with trading activity into the enclave over an encrypted channel terminating within the TEE, such that plaintext of the order-flow records does not exist outside the enclave during the covered interval (FIG. 2B).
III. Linkage-Analysis Module. The linkage-analysis module computes cryptographic account-linkage fingerprints from features of the order-flow and account-metadata records and identifies groupings of accounts whose pairwise linkage scores exceed a configured linkage threshold (FIG. 3A-3E). The account-linkage fingerprints are made available as attested output for downstream consumption.
IV. Surveillance Module (Detection Only). The surveillance module generates, based at least in part on the account groupings, raw trade-integrity signals comprising classifications of trade patterns as wash-trading indicators, coordinated-trading indicators, or collusion indicators, together with the account-linkage fingerprints (FIG. 4A-4E). These raw trade-integrity signals are made available for consumption by a companion verified prediction confidence scoring engine that computes a calibrated insider-risk indicator therefrom; the surveillance module performs detection only and does not compute the calibrated insider-risk indicator.
V. Attestation Module and Audit Ledger. The attestation module produces a hardware-attestation quote cryptographically binding a measurement of the surveillance code base, a cryptographic commitment to the order-flow and account-metadata records ingested during the covered interval, a cryptographic commitment to surveillance parameters including at least the configured linkage threshold, and the raw trade-integrity signals produced during the covered interval (FIG. 5A-5B). The hardware-attestation quote is verifiable by a relying party against a hardware-vendor attestation service independently of the exchange operator (FIG. 1E, FIG. 5E). A tamper-evident audit ledger organized as a Merkle accumulator maintains an append-only record of attestation quotes, its root periodically committed to an external public commitment channel, enabling verification of temporal integrity through Merkle inclusion proofs (FIG. 5C-5E).

### ENABLEMENT EXAMPLES

### Example 1 (Single-Exchange Intel SGX Detection)

Consider a hardware-attested trade integrity system executing within an Intel SGX enclave at a regulated prediction market exchange. The enclave loads and measures the surveillance code base. The order-intake interface delivers order-flow records and account-metadata records for a covered interval into the enclave over an encrypted channel terminating within the TEE. The linkage-analysis module computes account-linkage fingerprints and identifies a grouping of three accounts, A-1, A-2, and A-3, whose pairwise linkage scores (0.91, 0.88, 0.93) exceed the configured linkage threshold of 0.85, indicating non-independent control. The surveillance module classifies a sequence of offsetting trades among A-1 and A-2 as a wash-trading indicator and a coordinated bidding pattern across all three as a coordinated-trading indicator, and emits these raw trade-integrity signals together with the account-linkage fingerprints. The attestation module produces a hardware-attestation quote binding the surveillance code measurement, commitments to the ingested records and the linkage threshold, and the raw trade-integrity signals. A companion verified prediction confidence scoring engine consumes the attested signals to compute a calibrated insider-risk indicator; the trade integrity system itself does not compute that indicator. A regulator verifies the quote against the Intel attestation service, confirming the detections were produced by the measured code on the attested inputs without reliance on the exchange operator.

Operator-Non-Suppression Enforcement Embodiment. In an operator-non-suppression enforcement embodiment, every raw trade-integrity signal produced during the covered interval—including wash-trading, coordinated-trading, and collusion indicators, and including attested negative or low-magnitude results—is bound into the hardware-attestation quote before the quote is signed by the hardware-rooted attestation key. Because the signature covers a cryptographic commitment over the complete set of signals produced on the committed order-flow records, the exchange operator cannot omit an inconvenient detection, substitute a lower-severity classification, or alter the underlying order flow after the fact without producing a quote whose recomputed commitment no longer matches and whose verification against the hardware-vendor attestation service therefore fails. The order-flow records are decrypted only within the enclave and never written in plaintext to host memory or storage during the covered interval. The technical effect is a market-surveillance record that is tamper-evident against the very party being surveilled—a property not achievable by software-only surveillance, in which the operating exchange can alter inputs, suppress detections, or modify the surveillance code without detection by a relying regulator.

### Example 2 (Confidential-VM Deployment with Attested Negative Results)

Consider the system executing within an AMD SEV-SNP confidential virtual machine, ingesting a covered interval of order flow in which no account grouping exceeds the configured linkage threshold but a single account exhibits a rapid submit-and-cancel pattern. The surveillance module emits a coordinated-trading indicator of low magnitude and an empty collusion-indicator set, and the attestation module binds these raw signals, including the negative and low-magnitude results, into the hardware-attestation quote. The completeness of the attested record—including attested absence of higher-severity indicators—allows a downstream companion scoring engine and a relying regulator to distinguish a genuinely quiet interval from a suppressed one, because any alteration of the ingested order flow or the emitted signals after the covered interval invalidates verification of the quote against the AMD attestation service.
VI. Alternative Embodiments. The system may be practiced on any computer hardware providing the trusted-execution-environment properties described herein, and supports additional and successor TEE implementations and multi-vendor attestation. The classifications of raw trade-integrity signals are illustrative and non-limiting; additional embodiments classify further categories of trade-pattern anomaly. The disclosure herein supports, and the applicant reserves the right to pursue in one or more continuation or divisional applications, claims of broader or differing scope, including without limitation claims directed to hardware-attested trade-integrity detection for regulated electronic markets generally and claims directed to the account-linkage fingerprinting mechanism independent of the prediction-market context. Subject matter directed to a resolution-outcome oracle and to deterministic regulator re-execution of the surveillance code base, disclosed in the priority application, is reserved for separate applications and is not claimed herein. The foregoing embodiments are illustrative and non-limiting.

What is claimed is:

1. A hardware-attested trade integrity system for a prediction market exchange, comprising: (a) at least one hardware trusted execution environment configured to load a measured surveillance code base; (b) an order-intake interface configured to deliver order-flow records and account-metadata records associated with trading activity on the prediction market exchange into the hardware trusted execution environment over an encrypted channel terminating within the hardware trusted execution environment; (c) a linkage-analysis module executing within the hardware trusted execution environment and configured to compute cryptographic account-linkage fingerprints from features of said order-flow records and said account-metadata records, and to identify groupings of accounts whose pairwise linkage scores exceed a configured linkage threshold; (d) a surveillance module executing within the hardware trusted execution environment and configured to generate, based at least in part on said groupings, raw trade-integrity signals comprising classifications of trade patterns as wash-trading indicators, coordinated-trading indicators, or collusion indicators, together with the account-linkage fingerprints, said raw trade-integrity signals being made available for consumption by a companion verified prediction confidence scoring engine that computes a calibrated insider-risk indicator therefrom; and (e) an attestation module configured to produce a hardware-attestation quote cryptographically binding together (i) a measurement of the surveillance code base, (ii) a cryptographic commitment to the order-flow records and account-metadata records ingested during a covered interval, (iii) a cryptographic commitment to surveillance parameters including at least the configured linkage threshold, and (iv) the raw trade-integrity signals produced by the surveillance module during the covered interval, wherein the order-flow records are decrypted only within the hardware trusted execution environment and do not exist in plaintext outside the hardware trusted execution environment during the covered interval, wherein the raw trade-integrity signals are cryptographically bound by the hardware-attestation quote such that the operator of the prediction market exchange cannot suppress, alter, or selectively omit a raw trade-integrity signal produced during the covered interval without invalidating verification of the hardware-attestation quote, and wherein said hardware-attestation quote is verifiable by a relying party against a hardware-vendor attestation service independently of an operator of the prediction market exchange.

2. The system of claim 1, wherein the hardware trusted execution environment comprises at least one of Intel Software Guard Extensions, Intel Trust Domain Extensions, AMD Secure Encrypted Virtualization with Secure Nested Paging, and ARM Confidential Compute Architecture.

3. The system of claim 1, wherein the linkage-analysis module and the surveillance module together implement, within the hardware trusted execution environment, a detection pipeline comprising: extracting linkage features from the order-flow records and account-metadata records; computing pairwise account-linkage scores from the extracted features; grouping accounts whose pairwise linkage scores exceed the configured linkage threshold; and generating, from the resulting groupings, the raw trade-integrity signals, such that the raw trade-integrity signals and the configured linkage threshold are jointly bound into the hardware-attestation quote and the detection pipeline is verifiable as having been executed by the measured surveillance code base on the attested order-flow records.

4. The system of claim 1, wherein the linkage-analysis module is configured to compute the cryptographic account-linkage fingerprints from a feature vector comprising at least one of: a hashed funding-source identifier, a hashed settlement-counterparty identifier, an internet-protocol geolocation prefix, a device-attestation identifier, a temporal-pattern vector representing order-submission distributions, and a co-movement vector representing joint response to common market events.

5. The system of claim 1, wherein the hardware-attestation quote and the raw trade-integrity signals are formatted such that a relying party comprising a market regulator or a downstream institutional consumer integrates the attested trade-integrity record into a supervisory, surveillance, or compliance workflow, the relying party relying upon the independently verifiable hardware-attestation quote to evidence the integrity of the trade-integrity detection without participation of, or reliance on representations by, the operator of the prediction market exchange and without the relying party instantiating a hardware trusted execution environment at infrastructure of the relying party.

6. The system of claim 1, wherein the surveillance module is configured to classify a trade pattern as a collusion indicator upon identification, within a grouping of accounts identified by the linkage-analysis module, of temporally-correlated order-submission patterns exceeding a configured mutual-information threshold, or of coordinated response patterns in which accounts in said grouping systematically enter or exit positions within a configured response window of a specified trigger event.

7. The system of claim 1, wherein the raw trade-integrity signals made available for consumption by the companion verified prediction confidence scoring engine comprise the account-linkage fingerprints, anomalous-trade indicators, and cross-account coordination signals, from which the companion engine computes the calibrated insider-risk indicator at a configured z-score threshold, the trade integrity system itself not computing said calibrated insider-risk indicator.

8. The system of claim 1, further comprising a Merkle accumulator configured to append, within or under control of the hardware trusted execution environment, cryptographic digests of the raw trade-integrity signals produced by the surveillance module and of the hardware-attestation quotes produced by the attestation module, a root of said Merkle accumulator being periodically committed to an external public commitment channel.

9. A method of producing a regulator-verifiable trade integrity record for a prediction market exchange, the method comprising: loading a measured surveillance code base into a hardware trusted execution environment; ingesting, into the hardware trusted execution environment over an encrypted channel terminating within the hardware trusted execution environment, order-flow records and account-metadata records associated with trading activity on the prediction market exchange; decrypting the order-flow records only within the hardware trusted execution environment such that no plaintext of the order-flow records exists outside the hardware trusted execution environment during the covered interval; computing, within the hardware trusted execution environment, cryptographic account-linkage fingerprints from features of the ingested records; identifying, within the hardware trusted execution environment, account groupings having pairwise linkage scores exceeding a configured linkage threshold; generating, within the hardware trusted execution environment, raw trade-integrity signals comprising classifications of trade patterns among the identified account groupings as wash-trading indicators, coordinated-trading indicators, or collusion indicators, together with the account-linkage fingerprints, for consumption by a companion verified prediction confidence scoring engine that computes a calibrated insider-risk indicator therefrom; producing, within the hardware trusted execution environment, a hardware-attestation quote cryptographically binding the raw trade-integrity signals to a measurement of the surveillance code base, to a cryptographic commitment to the ingested records, and to a cryptographic commitment to surveillance parameters including at least the configured linkage threshold; and exporting the hardware-attestation quote and the raw trade-integrity signals in a form independently verifiable by a regulator against a hardware-vendor attestation service, without reliance on representations of an operator of the prediction market exchange, wherein the raw trade-integrity signals are cryptographically bound by the hardware-attestation quote such that the exchange operator cannot suppress or alter a produced raw trade-integrity signal without invalidating verification of the quote.

10. The method of claim 9, wherein the generating further comprises applying a configured risk-weighting to detected patterns based on at least one of trader capital at risk, account age, and historical prior-violation status, said risk-weighting being applied to the raw trade-integrity signals and distinct from any calibrated insider-risk indicator computed by the companion verified prediction confidence scoring engine.

11. The method of claim 9, wherein plaintext of the order-flow records and account-metadata records is not exposed outside the hardware trusted execution environment at any point during the computing, identifying, and generating steps.

12. The method of claim 9, wherein the exporting further comprises generating and exporting, together with the hardware-attestation quote and the raw trade-integrity signals, a zero-knowledge proof attesting that the raw trade-integrity signals were computed on inputs consistent with an external commitment, without disclosing plaintext of the order-flow records or account-metadata records to the regulator.

13. The method of claim 9, further comprising generating, within the hardware trusted execution environment, real-time alerts to an exchange compliance officer upon production of raw trade-integrity signals exceeding a configured severity threshold, wherein said alerts are themselves accompanied by hardware-attestation quotes produced within the hardware trusted execution environment.

14. The method of claim 9, further comprising (i) integrating into the cryptographic account-linkage fingerprints at least one know-your-customer attestation and at least one anti-money-laundering attestation received from a regulated counterparty in cryptographically signed form, and (ii) transmitting the hardware-attestation quote and the raw trade-integrity signals to a regulatory reporting endpoint in a format compliant with an applicable reporting schema for prediction-market instruments.

15. A non-transitory computer-readable medium storing program instructions that, when executed within a hardware trusted execution environment of a computer system, cause the hardware trusted execution environment to perform operations comprising: receiving, over an encrypted channel terminating within the hardware trusted execution environment, order-flow records and account-metadata records associated with trading activity on a prediction market exchange; computing cryptographic account-linkage fingerprints from features of the received records; identifying account groupings having pairwise linkage scores exceeding a configured linkage threshold; generating raw trade-integrity signals comprising classifications of trade patterns among the identified account groupings as wash-trading indicators, coordinated-trading indicators, or collusion indicators, together with the account-linkage fingerprints, for consumption by a companion verified prediction confidence scoring engine that computes a calibrated insider-risk indicator therefrom; producing a hardware-attestation quote cryptographically binding the raw trade-integrity signals to a measurement of the program instructions, to a cryptographic commitment to the received records, and to a cryptographic commitment to surveillance parameters including at least the configured linkage threshold; and causing export of the hardware-attestation quote and the raw trade-integrity signals in a form independently verifiable by a regulator against a hardware-vendor attestation service, wherein the order-flow records do not exist in plaintext outside the hardware trusted execution environment during the covered interval and the raw trade-integrity signals are tamper-evidently bound such that the exchange operator cannot suppress or alter a produced signal without invalidating verification of the hardware-attestation quote.

16. The non-transitory computer-readable medium of claim 15, wherein the operations further comprise receiving hardware-attestation quotes from at least one additional prediction-market exchange operating a corresponding hardware trusted execution environment and producing, based at least in part on said received quotes, a cross-exchange attestation record binding account-linkage findings across the coupled prediction-market exchanges, wherein the prediction market exchange operates at least one of binary option contracts, event contracts, categorical outcome contracts, and scalar outcome contracts under an applicable regulatory designation.
